(19) United States
(12) Patent Application Publication
(10) Pub. No.: US 2023/0287947 A1
(43) Pub. Date: Sep. 14, 2023

(54) AUTOMOTIVE ELECTRO-MECHANICAL BRAKE

(71) Applicants: Hyundai Motor Company, Seoul (KR); Kia Corporation, Seoul (KR)

(72) Inventors: Sang Woo Hwang, Seoul (KR); Youngil Sohn, Yongin-Si (KR); Sehyun Chang, Suwon-Si (KR); Min Jun Kim, Busan (KR)

(73) Assignees: Hyundai Motor Company, Seoul (KR); Kia Corporation, Seoul (KR)

(21) Appl. No.: 18/078,625

(22) Filed: Dec. 9, 2022

(30) Foreign Application Priority Data
Mar. 14, 2022 (KR) 10-2022-0031134

(51) Int. Cl. F16D 65/18

(52) U.S. Cl. CPC F16D 65/18; F16D 2121/24

(57) ABSTRACT

An automotive electro-mechanical brake apparatus includes a clamping unit provided to be able to axial move forwards and rearwards thereof along a torque member and configured to press a disc through a friction pad by moving rearward in braking, a pressing unit accommodated in the clamping unit, selectively moving forward or rearward when rotation is input thereto, and configured to move forward, press the disc through the friction pad, and guide rearward movement of the clamping unit in braking, a gear unit engaged with the pressing unit, and a clutch unit connected to the gear unit, configured to transmit rotational driving force for inputting the rotation to the pressure unit to the gear unit, and configured to prevent displacement against reverse rotation input from the gear unit in driving.

### CROSS REFERENCE TO RELATED APPLICATION

The present application claims priority to Korean Patent Application No. 10-2022-0031134, filed Mar. 14, 2022, the entire contents of which is incorporated herein for all purposes by this reference.

### BACKGROUND OF THE PRESENT DISCLOSURE

### Field of the Present Disclosure

The present disclosure relates to an automotive electro-mechanical brake apparatus, and more particularly, to an automotive electro-mechanical brake apparatus that assists a driving force of a motor by applying a pressing spring, prevents continuous motor load when a vehicle is stopped by being provided with a clutch to prevent back drive, and prevents displacement against reverse input of the motor while a vehicle is normally driven.

### DESCRIPTION OF RELATED ART

In general, according to a hydraulic brake, when a driver depresses a brake pedal, hydraulic pressure is generated in a master cylinder and is transmitted to the caliper of a wheel and a brake pad perpendicularly presses a disc, whereby braking is performed.

A method of braking a vehicle by generating a braking force through a mechanical hydraulic brake is generally used, but Electro-Mechanical Brakes (EMB) that generate a braking force using the rotation force of an electric motor are recently developed in various types.

In general, such an electro-mechanical brake system is composed of an electric driving motor, a motor driver, a brake structure, and a sensor, in which the sensor measures a speed, a current, and pressing force of the driving motor and sends a feedback signal, and a driving unit of the electro-mechanical brake system safely and accurately drives the system based on the feedback signal.

That is, an electro-mechanical brake system of an electro-mechanical brake system the presses a piston by converting rotation force of a driving motor into a straight motion using a screw and a nut mechanism without using hydraulic pressure. In such an electro-mechanical brake system, when a screw gear is rotated by a gear amplifying the rotation force of a driving motor, a spindle converts the rotation motion of the screw gear into a straight motion and presses a piston and the pressed piston presses a pad toward a wheel disc, whereby a caliper body is moved by a reaction force by the piston force.

Because such an electro-mechanical brake does not use hydraulic pressure, not only it is eco-friendly, but the response speed is higher than a hydraulic brake due to a quick response characteristic of the driving motor. Furthermore, because it is possible to accurately know torque of the driving motor through a current sensor, it is possible to separately control the braking force of wheels, so there is an advantage of high accuracy.

Because the electro-mechanical brake is electronically operated, unlike a hydraulic brake of the related art, an ECU should be continuously operated to drive an EMB actuator.

However, the electro-mechanical brake of the related art has a problem that power consumption is increased due to continuous operation of an ECU even though the electro-mechanical brake is not operated for a long time, for example, when a vehicle with the electro-mechanical brake is parked, and accordingly, there is a problem that thermal overload is applied to the driving motor.

Furthermore, the capacity and size of an EMB actuator should be large to normally and continuously operate an electro-mechanical brake, but in the instant case, the advantage in terms of space usability of the EMB actuator is unavoidably removed, and the large volume acts as a defect in a small space in a tire.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an automotive electro-mechanical brake apparatus that can assist a driving force of a motor by applying a pressing spring, can prevent continuous motor load and increase energy efficiency when a vehicle is stopped by being provided with a clutch, which is configured to prevent back drive, and can prevent displacement against reverse input of the motor while a vehicle is normally driven, that is, can prevent clamping of a disc while a vehicle is normally driven without input from a motor configured for braking by prevent drag of a lead nut due to a pressing spring.

An automotive electro-mechanical brake apparatus according to an exemplary embodiment of the present disclosure includes: a clamping unit engaged to a torque member, and configured to move forwards and rearwards along the torque member and to press a disc through a friction pad by moving rearward in braking; a pressing unit accommodated in the clamping unit, selectively moving forward or rearward when rotation is input thereto, and configured to move forward, press the disc through the friction pad, and guide rearward movement of the clamping unit in the braking; a gear unit engaged with the pressing unit; and a clutch unit connected to the gear unit, configured to transmit rotational driving force for inputting the rotation to the pressure unit to the gear unit, and configured to prevent displacement against reverse rotation input from the gear unit in driving.

The clamping unit may include: a clamper body coupled to guide rods of the torque member, accommodating the pressing unit therein, and configured to be moved forward and rearward by the pressing unit; a clamper rod slidably coupled to the torque member and configured to move in a movement direction of the clamper body together with the clamper body; and a clamper connected to an end portion of the clamper rod with the friction pad mounted on the clamper and configured to guide the clamper rod so that the disc is pressed by the friction pad when the clamper rod is moved rearward in the braking.

The clamping unit may further include an elastic member disposed between the clamper body and the clamper rod and configured to be compressed by the clamper body and the clamper rod so that the clamper rod is selectively pressed when the clamper body is moved rearward thereof.

The automotive electro-mechanical brake apparatus may further include an LVDT sensor configured to measure an amount of pressing of the friction pad by the pressing unit by measuring a displacement of the elastic member between the clamper body and the clamper rod.

The pressing unit may include: a lead nut disposed to face the friction pad; a screw, a first end portion of which is inserted and thread-fastened in the lead nut; and a movement guide member coupled to a second end portion of the screw, gear-engaged with the gear unit, and configured to move forward the lead nut so that the friction pad is selectively pressed by the lead nut and the disc is pressed by the friction pad when rotation for the braking is input to the movement guide member.

The pressing unit may further include a spring positioned in a hollow portion of the clamping unit and configured to assist a force for pressing the friction pad by providing elasticity to the friction pad when the lead nut is moved forward thereof.

The clutch unit may include: a housing; a cover positioned at an end portion of the housing; an external shaft at least partially positioned in the housing and including an end portion connected to the gear unit through the housing; a plurality of lockers positioned in the housing to surround the external shaft; and an input shaft connected to a control motor and including a first end portion inserted into openings of the lockers and a second end portion connected to the control motor through the cover, and wherein the external shaft may be restricted by the lockers so that the external shaft and the lockers are rotated in a rotation direction of the input shaft.

The clutch unit may further include: a steel portion positioned on an internal surface of the housing; and a magnetic member positioned on an external surface, which faces the steel member, of at least one of the lockers.

The magnetic members on the lockers may be positioned adjacent to the steel member when rotation force of the input shaft is removed from the input shaft.

The clutch unit may further include a braking portion positioned adjacent to the steel member and configured to selectively come in contact with the lockers, and the external surfaces of the lockers may come in contact with the braking portion when the magnetic members are positioned adjacent to the steel member.

The present disclosure has an effect that it is possible to assist a driving force of a motor by applying a pressing spring, to prevent continuous motor load and increase energy efficiency when a vehicle is stopped by being provided with a clutch, which is configured to prevent back drive, and to prevent displacement due to reverse input of the motor while a vehicle is normally driven, that is, to prevent clamping of a disc while a vehicle is normally driven without input from a motor configured for braking by prevent drag of a lead nut due to a pressing spring.

Accordingly, because it is possible to assist the driving force of the motor through the pressing spring, the present disclosure has an effect that it is possible to reduce the magnitude of maximum output required for the motor, so it is possible to decrease the manufacturing cost, the weight, etc.

Furthermore, because it is possible to prevent displacement against reverse input of a motor while a vehicle is stopped, it is possible to provide a rest time for the motor. Accordingly, the present disclosure has an effect that it is possible to increase energy efficiency and it is possible to provide an advantage in terms of heat management for the motor by increasing the rest time for the motor.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a side view showing the structure of an automotive electro-mechanical brake apparatus according to an exemplary embodiment of the present disclosure;

FIG. 2 is top cross-sectional view showing the structure of the automotive electro-mechanical brake apparatus according to an exemplary embodiment of the present disclosure;

FIG. 3 is a side view showing the operation in driving of the automotive electro-mechanical brake apparatus according to an exemplary embodiment of the present disclosure;

FIG. 4 is a side view showing the operation in braking of the automotive electro-mechanical brake apparatus according to an exemplary embodiment of the present disclosure;

FIG. 5, FIG. 6, FIG. 7 and FIG. 8 are views showing a clutch unit of the automotive electro-mechanical brake apparatus according to an exemplary embodiment of the present disclosure;

FIG. 9 is a side view showing the operation of the clutch unit in driving of the automotive electro-mechanical brake apparatus according to an exemplary embodiment of the present disclosure; and

FIG. 10 is a side view showing the operation of the clutch unit in braking of the automotive electro-mechanical brake apparatus according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to accompanying drawings.

The advantages and features of the present disclosure, and methods of achieving them will be clear by referring to the exemplary embodiments that will be described hereafter in detail with reference to the accompanying drawings.

However, the present disclosure is not limited to the exemplary embodiments described hereafter and may be implemented in various ways, the exemplary embodiments are provided to complete the description of the present disclosure and let those skilled in the art completely know the scope of the present disclosure, and the present disclosure is defined by claims.

Furthermore, when it is determined that well-known technologies, etc. may make the scope of the present disclosure unclear, they will be omitted in detail in the following description.

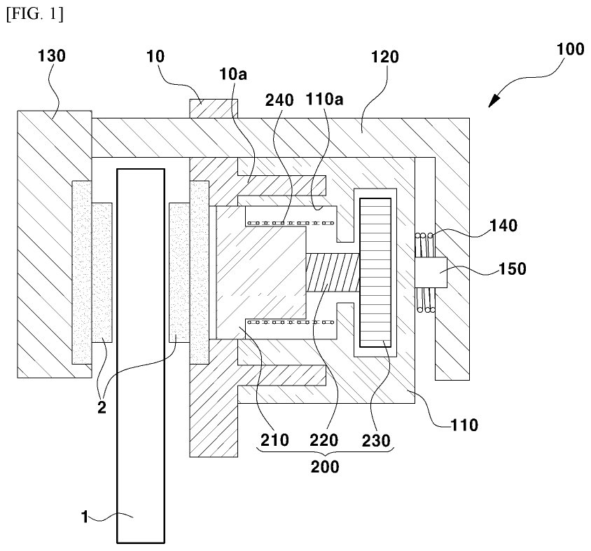

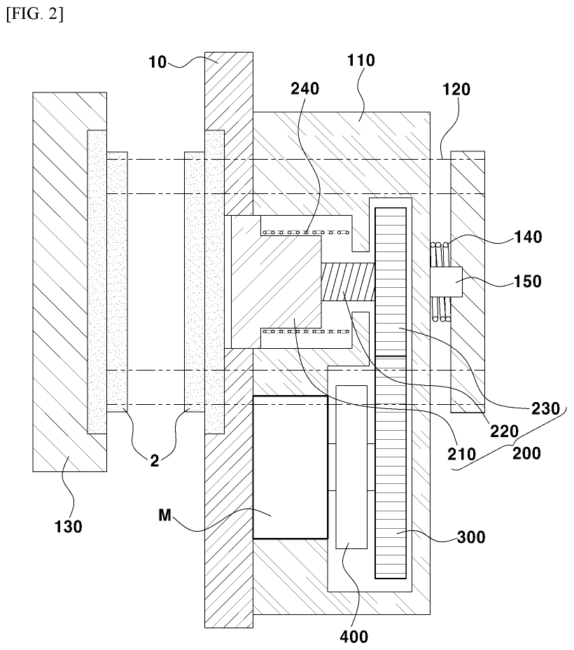

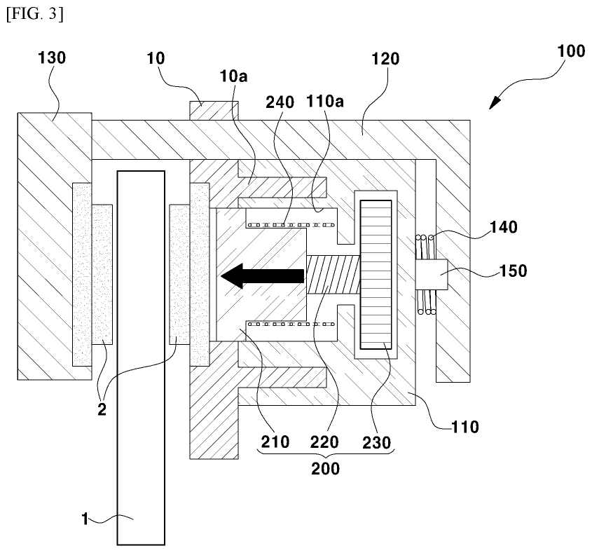

FIG. 1 is a side view showing the structure of an automotive electro-mechanical brake apparatus according to an exemplary embodiment of the present disclosure, FIG. 2 is top cross-sectional view showing the structure of the automotive electro-mechanical brake apparatus according to an exemplary embodiment of the present disclosure, and FIG. 3 is a side view showing the operation in driving of the automotive electro-mechanical brake apparatus according to an exemplary embodiment of the present disclosure.

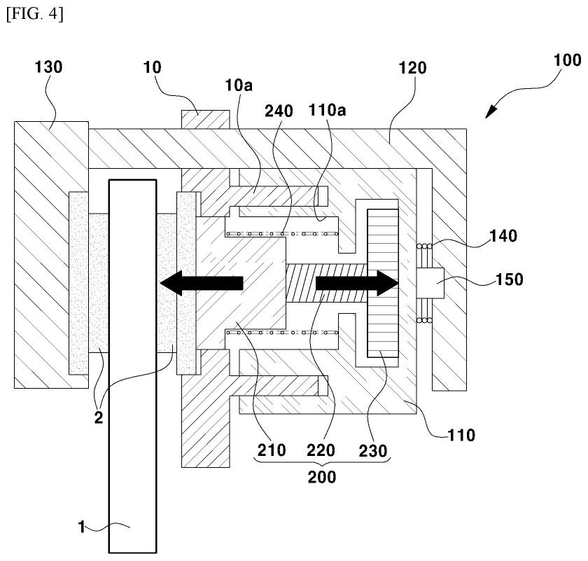

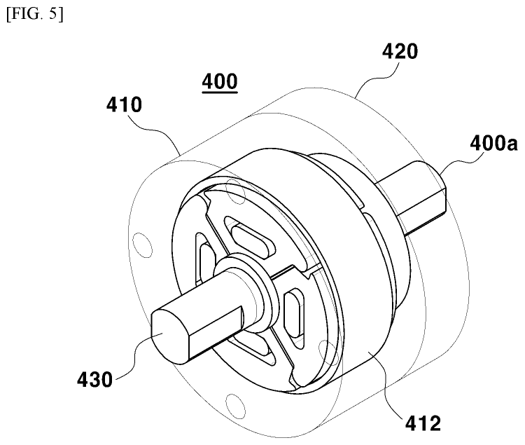

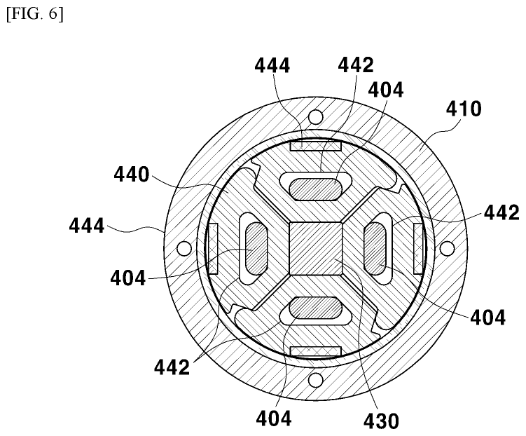

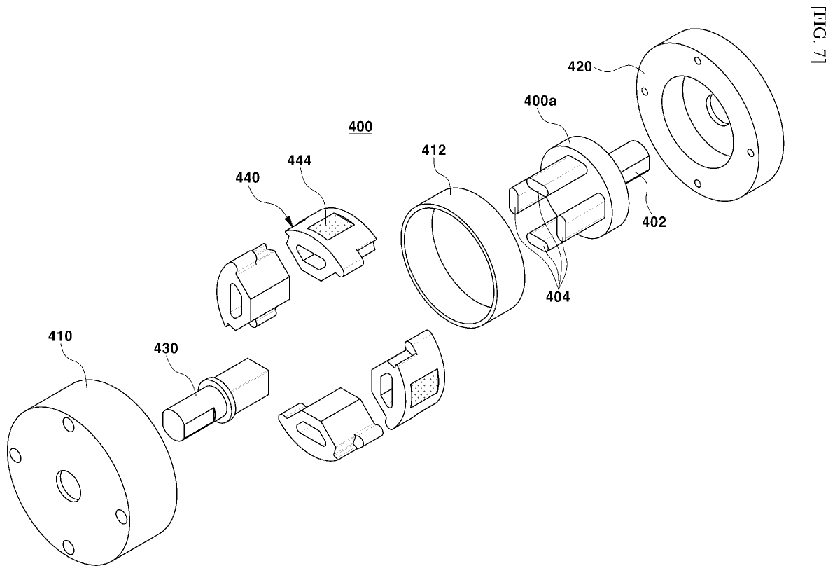

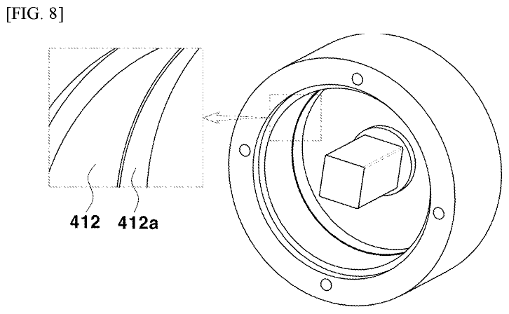

FIG. 4 is a side view showing the operation in braking of the automotive electro-mechanical brake apparatus according to an exemplary embodiment of the present disclosure, FIG. 5, FIG. 6, FIG. 7 and FIG. 8 are views showing a clutch unit of the automotive electro-mechanical brake apparatus according to an exemplary embodiment of the present disclosure,

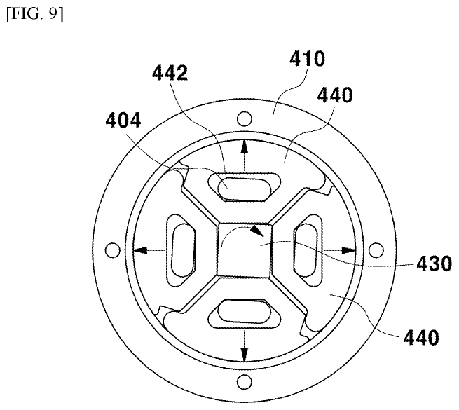

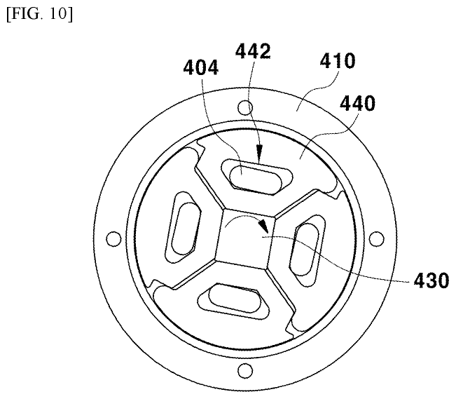

FIG. 9 is a side view showing the operation of the clutch unit in driving of the automotive electro-mechanical brake apparatus according to an exemplary embodiment of the present disclosure, and FIG. 10 is a side view showing the operation of the clutch unit in braking of the automotive electro-mechanical brake apparatus according to an exemplary embodiment of the present disclosure.

As shown in FIGS. 1 to 2, an automotive electro-mechanical brake apparatus according to the exemplary embodiment of the present disclosure includes a clamping unit 100, a pressing unit 200, a gear unit 300 and a clutch unit 400.

The clamping unit 100 can axially move forwards and rearwards thereof along a fixed torque member 10.

That is, the clamping unit 100 is configured to push a disc 1, which is rotated with a wheel, friction pads 2 to brake a vehicle. When the vehicle is braked, the clamping unit 100 is moved rearward thereof, so that the disc 1 is pressed through the friction pads 2.

To the present end, the clamping unit 100 includes a clamper body 110, a clamper rod 120, and a clamper 130.

The clamper body 110 is coupled to a plurality of guide rods 10a of the torque member 10 and is selectively moved forward or rearward along the guide rods 10a.

The damper body 110 accommodates the pressing unit 200 therein, and accordingly, the damper body 110 may be moved forward and rearward by the pressing unit 200.

The clamper rod 120 extends with a predetermined length, and when the clamper body 110 is moved, for example, when the clamper body 110 is moved rearward thereof, the clamper rod 120 is pressed by the clamper body 110 and moved rearward with the clamper body 110.

The clamper 130 is integrally coupled to the clamper rod 120 with a friction pad 2 thereon. In braking, the clamper rod 120 is moved rearward thereof, so that the clamper 130 is pulled, whereby the friction pad 2 is guided to press a first side of the disc 1.

The clamping unit 100 may further include an elastic member 140. The elastic member 140 is disposed at positions opposite each other of the clamper body 110 and the clamper rod 120 and is compressed when the clamper body 110 is moved rearward to selectively press the clamper rod 120.

The elastic member 140 presses a second side of the disc 1 when the pressing unit 200 is operated. When the clamper body 110 is moved rearward by the pressing unit 200, an elastic return force of the elastic member 140 in a compressed state is transmitted to the clamper rod 120, whereby a first side of the disc 1 is effectively pressed.

A Linear Variable Differential Transformer (LVDT) sensor 150 may be disposed between the clamper body 110 and the clamper rod 120 where the elastic member 140 is positioned. It is possible to measure the degree of pressing of the friction pad 2 against the pressing unit 200 by measuring displacement of the elastic member 140 through the LVDT sensor 150.

That is, because the pressing unit 200 is selectively moved forward or rearward by a control motor M, it is difficult to estimate the force that clamps the disc when clamping the disc 1 through the friction pad 2, so it is possible to estimate the degree of the force that clamps the disc 1 by measuring displacement of the elastic member 140 through the LVDT sensor 150.

The LVDT sensor 150 is a common electric converter which is configured to measure a linear distance different, that is, a transducer that changes magnetic flux, that is, mutual inductance which is generated between a primary coil and a secondary coil through mechanical displacement.

The LVDT sensor 150 enables precise measurement with small influence by environmental changes and is generally used in the industry, universities, and laboratories, so that the structure and operation thereof are not described in detail in the exemplary embodiment of the present disclosure.

Meanwhile, the pressing unit 200 is accommodated in the clamper body 110 of the clamping unit 100 and receives rotation input of the control motor M through the gear unit 300, so that the pressing unit 200 may be selectively moved forward or rearward thereof. In braking, the pressing unit 200 is moved forward and presses the second side 1 through a friction pad 2.

The pressing unit 200 can guide rearward movement with respect to the clamper body 110 when moving forward to press the second side of the disc 1.

To the present end, the pressing unit 200 may include a lead nut 210, a screw 220, and a movement guide member 230.

The lead nut 210 is disposed to face the friction pad 2 for pressing the second side of the disc 1.

The screw 220 is inserted and thread-fastened inside the lead nut 210, and accordingly, when the screw 220 is rotated, the screw 220 can axially move forward and rearward while rotating with respect to the lead nut 210.

The movement guide member 230 is coupled to the screw 220 and engaged with the gear unit 300. When rotation is input from the control motor M for braking, the input rotation is transmitted to the movement guide member 230 by the structure engaged with the gear unit 300, the lead nut 210 is loosened, that is, moved forward and selectively presses a friction pad 20, whereby the second side of the disc 1 is pressed by the friction pad 2.

The pressing unit 200 may further include a spring 240. The spring 240 is disposed in a hollow portion 110a of the clamper body 110 and provides elasticity when the lead nut 210 is moved forward to assist the force for pressing a friction pad 2.

Operation for clamping the first side and the second side of the disc 1 based on the configuration of the pressing unit 200 is described hereafter with reference to FIG. 1 and FIG. 2.

First, when the control motor M is driven for braking, the movement guide member 230 is rotated by the gear unit 300, and accordingly, the screw 220 is rotated, that is, is loosened while rotating, as shown in FIG. 4, whereby the lead nut 210 is moved forward thereof.

When the lead nut 210 is moved forward and brought in contact with a friction pad 2, a larger force is applied to the lead nut 210 by the spring 240, whereby the second side of the disc 1 is clamped by the friction pad 2. Thereafter, when the movement guide member 230 is moved away from the friction pad 2 while rotating, the clamper body 110 accommodating the movement guide member 230 moves rearward and presses the clamper rod 120 through the elastic member 140, whereby the first side of the disc 1 is clamped by another disc pad 2.

On the other hand, in driving, the clamper body 110 is moved forward to a predetermined position by rotation of the movement guide member 230 (elastic force of the elastic member 140 not applied), and then the lead screw 210 is moved rearward in the screw-coupling direction, that is, moved away from the friction pad 2 by additional rotation, as shown in FIG. 3. Accordingly, in driving, clamping the first side and the second side of the disc 1 through the friction pads 2 may be removed.

However, in the instant state, a force that moves the lead nut 210 to press a friction pad 2 is generated, that is, the force is transmitted by the elastic return force of the spring 240, so that the lead unit 210 and the screw 220 are rotated, which results in a problem that a braking force intervenes in driving.

To solve the present problem, in the exemplary embodiment of the present disclosure, a clutch unit 400 may be provided and is connected to the gear unit 300. When the control motor M is driven in braking, the clutch unit 400 transmits a rotational driving force for inputting rotation to the movement guide member 230 to the gear unit 300, and prevents displacement against reverse rotation input from the pressing unit 200 including the lead nut 210 in driving.

The clutch unit 400, as shown in FIGS. 5 to 8, includes a housing 410, a cover 420, an external shaft 430, a locker 440, and an input shaft 400a.

That is, the clutch unit 400 includes a housing 410 and a cover 420 configured to cover a first end portion which is open of the housing 410 at the first end portion of the housing 410. The housing 410 has a circular cross-section and the cover 420 is configured to fully cover the opening at a first end portion of the housing 410 and has the external shaft 430 disposed through another end portion of the housing 410 and including at least one flat surface.

a plurality of lockers 440 configured to surround the flat surfaces of the external shaft 430 are disposed in the housing 410 and the input shaft 400a has a first end portion inserted in openings 442 of the lockers 440, respectively. The external shaft 430 has flat surfaces corresponding to the number of the lockers 440 disposed in the housing 410.

The external shaft 430 according to the exemplary embodiment of the present disclosure may have four flat surfaces corresponding to four lockers 440, and the flat surfaces of the external shaft 430 come in contact with adjacent lockers 440 when rotation force of the input shaft 400a is applied, whereby the lockers 440 and the external shaft 430 may be configured to selectively come in surface-contact with each other.

The input shaft 400a is configured so that at least a portion of the longitudinal direction is inserted in the openings 442 of the lockers 440, and has an operation transmission portion 402 at a second end portion that protrudes through the cover 420 to the outside of the cover 420. The operation transmission portion 402 is fastened to the control motor M that applies rotation force to be integrally rotated with the control motor M in the rotation direction of the control motor M.

The rotation force of the control motor M is transmitted to the operation transmission portion 402 at the second end portion of the input shaft 400a, and the driving force applied to the operation transmission portion 402 rotates the external shaft 430 through rotation transmission portions 404.

The control motor M is configured to transmit a driving force that can rotate the input shaft 400a, and the lockers 440 are brought in contact with the flat surfaces of the external shaft 430 by the rotation force of the input shaft 400a.

The clutch unit 400 according to the exemplary embodiment of the present disclosure includes all types of clutches which may be fastened to a motor, and may be positioned at an end portion of a motor configured to apply a driving force for a vehicle, an end portion of a motor moving upwards and downwards a window, an end portion of a motor inputting a steering angle of an independent corner module, and an end portion of a posture control motor for controlling the posture of a vehicle body. Furthermore, the clutch unit may be used as a clutch which is fastened to an engine as a driving unit to transmit a driving force in one direction between the gear unit of a transmission and an engine.

The input shaft 400a has the rotation transmission portions 404 inserted into the openings 442 formed in the lockers 440, respectively. In the exemplary embodiment of the present disclosure, four rotation transmission portions 404 corresponding to four lockers 440 are provided and may be inserted in the openings 442 formed in the lockers 440, respectively. The rotation transmission portions 404 are rotated in a same direction of the operation transmission portion 402, and the locker 440 that come in contact with the rotation transmission portions 404 through the openings 442 are integrally rotated in correspondence to the rotation direction of the input shaft 400a.

The lockers 440 may be positioned in the housing 410, and the flat surfaces of the external shaft 430 and the lockers 440 may be positioned adjacent to each other, respectively. The lockers 440 are divided into at least two or more groups and are disposed with predetermined gaps between the flat surfaces of the external shaft 430 and the housing 410. The flat surfaces of the external shaft 430 are provided in the same number as the lockers 440, and the internal surfaces of the lockers 440 may be positioned adjacent to the flat surfaces of the external shaft 430, respectively.

When a rotation force is applied to the input shaft 400a, first internal end portions of the lockers 440 may come in contact with the flat surfaces of the external shaft 430 with predetermined gaps from the internal surface of the housing 410 so that the input shaft 400a, the lockers 440, and the external shaft 430 are integrally rotated without interference with the internal surface of the housing 410.

A steel member 412 is disposed on the internal surface of the housing 410 and magnetic members 444 are disposed on the external surfaces of the lockers 440. Accordingly, when rotation force of the input shaft 400a is removed, the magnetic members 444 of the lockers 440 may be moved close to the internal surface of the housing 410. A braking portion 412a disposed adjacent to the steel member 412 and close to the internal surface of the housing 410 is further provided (see FIG. 8), whereby the external surfaces of the lockers 440 are moved to come in contact with the braking portion 412a by magnetic force, restricting movement of the input shaft 400a.

Even though rotation force of the external shaft 430 is applied, the flat surfaces of the external shaft 430 radially push the lockers 440 so that the braking portion 412a on the internal surface of the housing 410 and the external surfaces of the lockers 440 are fixed in contact with each other, whereby it is possible to prevent the rotation force of the external shaft 430 from being transmitted to the input shaft 400a. The braking portion 412a may be positioned further adjacent to the lockers 440 than the steel member 412 and direct contact of the magnetic members 444 of the lockers 440 with the steel member 412 may be prevented.

A predetermined gap may be formed between the lockers 440 and the internal surface of the housing 410 in accordance with the positions of the lockers 440. Accordingly, when the driving force of the input shaft 400a is removed, the external surfaces of the lockers 440 are moved close to the internal surface of the housing 410 by the magnetic force of the magnetic members 444 so that the gap between the internal surface of the housing 410 and the external surfaces of the lockers 440 is minimized.

However, when the input shaft 400a is rotated, the rotation transmission portions 404 of the input shaft 400a come in contact with width-directional end portions of the openings 442 of the lockers and can apply rotation force so that the lockers 440 rotate in the rotation force direction of the control motor M. In the instant case, the lockers 440 are in contact with the flat surfaces of the external shaft 430, so that the gap between the internal surface of the housing 410 and the external surfaces of the lockers 440 is minimized. Accordingly, the lockers 440 restrict the external shaft 430 in a surface-contact state without generating reaction force with the housing 410 in correspondence to rotation of the input shaft 400a.

As described above, the clutch unit 400 according to the exemplary embodiment of the present disclosure may be configured so that the external shaft 430 is integrally rotated with the lockers 440 spaced from the internal surface of the housing 410 in correspondence to the input shaft 400 rotating in the rotation direction of the control motor M. When the rotation force applied to the input shaft 400a is removed, the braking portion 412a and the lockers 440 restrict movement of the input shaft 400a in contact with each other, preventing a back drive phenomenon.

That is, the clutch unit 400, as shown in FIG. 10, is configured so that the external shaft 430 is rotated in the rotation direction of the control motor M so that the movement guide member 230 is rotated by the gear unit 300 in braking, in more detail, the screw 220 and the lead nut 210 are sequentially rotated, whereby the disc 1 may be clamped by an advance of the lead nut 210.

However, when the rotation force applied to the input shaft 400a is removed, the braking portion 412a and the lockers 440 of the clutch unit 400 restrict movement of the input shaft 400a in contact with each other, whereby it is possible to prevent a back drive phenomenon in driving, as shown in FIG. 9. As a result, it is possible to increase energy efficiency by preventing continuous load of the control motor in braking and it is possible to solve the problem that the disc 1 is clamped by the lead nut 210 in driving by preventing displacement against reverse rotation input, that is, preventing drag of the lead nut 210 by the spring 240.

The present disclosure has an effect that it is possible to assist a driving force of a motor by applying a pressing spring, to prevent continuous motor load and increase energy efficiency when a vehicle is stopped by being provided with a clutch, which is configured to prevent back drive, and to prevent displacement against reverse input of the motor while a vehicle is normally driven, that is, to prevent clamping of a disc while a vehicle is normally driven without input from a motor for braking by prevent drag of a lead nut due to a pressing spring.

Accordingly, because it is possible to assist the driving force of the motor through the pressing spring, the present disclosure has an effect that it is possible to reduce the magnitude of maximum output required for the motor, so it is possible to decrease the manufacturing cost, the weight, etc.

Furthermore, because it is possible to prevent displacement against reverse input of a motor while a vehicle is stopped, it is possible to provide a rest time for the motor. Accordingly, the present disclosure has an effect that it is possible to increase energy efficiency and it is possible to provide an advantage in terms of heat management for the motor by increasing the rest time for the motor.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An automotive electro-mechanical brake apparatus comprising:
a clamping unit engaged to a torque member, and configured to move forwards and rearwards along the torque member and to press a disc through a friction pad by moving rearward in braking;
a pressing unit accommodated in the clamping unit, selectively moving forward or rearward when rotation is input thereto, and configured to move forward, press the disc through the friction pad, and guide rearward movement of the clamping unit in the braking;
a gear unit engaged with the pressing unit; and
a clutch unit connected to the gear unit, configured to transmit rotational driving force for inputting the rotation to the pressure unit to the gear unit, and configured to prevent displacement against reverse rotation input from the gear unit in driving.

2. The automotive electro-mechanical brake apparatus of claim 1, wherein the clamping unit includes:
a clamper body coupled to guide rods of the torque member, accommodating the pressing unit therein, and configured to be moved forward and rearward by the pressing unit;
a clamper rod slidably coupled to the torque member and configured to move in a movement direction of the clamper body together with the clamper body; and
a clamper connected to an end portion of the clamper rod with the friction pad mounted on the clamper and configured to guide the clamper rod so that the disc is pressed by the friction pad when the clamper rod is moved rearward in the braking.

3. The automotive electro-mechanical brake apparatus of claim 2, wherein the clamping unit further includes an elastic member disposed between the clamper body and the clamper rod and configured to be compressed by the clamper body and the clamper rod so that the clamper rod is selectively pressed when the clamper body is moved rearward thereof.

4. The automotive electro-mechanical brake apparatus of claim 3, further including:
a Linear Variable Differential Transformer (LVDT) sensor configured to measure an amount of pressing of the friction pad by the pressing unit by measuring a displacement of the elastic member between the clamper body and the clamper rod.

5. The automotive electro-mechanical brake apparatus of claim 1, wherein the pressing unit includes:
a lead nut disposed to face the friction pad;
a screw, a first end portion of which is inserted and thread-fastened in the lead nut; and
a movement guide member coupled to a second end portion of the screw, gear-engaged with the gear unit, and configured to move forward the lead nut so that the friction pad is selectively pressed by the lead nut and the disc is pressed by the friction pad when rotation for the braking is input to the movement guide member.

6. The automotive electro-mechanical brake apparatus of claim 5, wherein the pressing unit further includes a spring positioned in a hollow portion of the clamping unit and configured to assist a force for pressing the friction pad by providing elasticity to the friction pad when the lead nut is moved forward thereof.

7. The automotive electro-mechanical brake apparatus of claim 1, wherein the clutch unit includes:
a housing;
a cover positioned at an end portion of the housing;
an external shaft at least partially positioned in the housing and including an end portion connected to the gear unit through the housing;
a plurality of lockers positioned in the housing to surround the external shaft; and
an input shaft connected to a control motor and including a first end portion inserted in openings of the lockers and a second end portion connected to the control motor through the cover, and
wherein the external shaft is restricted by the lockers so that the external shaft and the lockers are rotated in a rotation direction of the input shaft.

8. The automotive electro-mechanical brake apparatus of claim 7, wherein the first end portion of the input shaft includes a plurality of rotation transmission portions slidably engaged to each corresponding opening of the lockers.

9. The automotive electro-mechanical brake apparatus of claim 7, wherein the clutch unit further includes:
a steel portion positioned on an internal surface of the housing; and
a magnetic member positioned on an external surface, which faces the steel member, of at least one of the lockers.

10. The automotive electro-mechanical brake apparatus of claim 9, wherein the magnetic members on the lockers are positioned adjacent to the steel member when rotation force of the input shaft is removed from the input shaft.

11. The automotive electro-mechanical brake apparatus of claim 10,
wherein the clutch unit further includes a braking portion positioned adjacent to the steel member and configured to selectively come in contact with the lockers, and
wherein external surfaces of the lockers come in contact with the braking portion when the magnetic members are positioned adjacent to the steel member.
